(19) United States
(12) Patent Application Publication
(10) Pub. No.: US 2003/0077434 A1
(43) Pub. Date: Apr. 24, 2003

(54) Method for manufacturing a thermally sprayed layer

(76) Inventors: Franz Jansen, Winterthur (CH); Rajiv Damani, Winterthur (CH); Werner Straub, Oberstammheim (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/273,800

(22) Filed: Oct. 17, 2002

(30) Foreign Application Priority Data
Oct. 19, 2001 (EP) 01 811 022.1

(51) Int. Cl. B32B 1/00

(52) U.S. Cl. 428/220; 427/446

(57) ABSTRACT

With the method for manufacturing a thermally sprayed layer (2) on a substrate (1), in particular a ceramic coating is applied to a metallic body. The sprayed layer is applied to a structured surface (3, 10) of the substrate. The surface structure (3) of the substrate is produced by material removal by means of a high pressure liquid jet (4). A removal point (40) is thereby controlledly moved on the substrate while producing a macro-topography, namely by moving the liquid jet and/or the substrate. A groove-like removal track (41) is produced by the material removal which can be in a straight line or curved and which has a micro-topography. A macro-profile (3′) of the macro-topography is manufactured by placing a plurality of removal tracks next to one another and by partial overlapping of these removal tracks. This macro-profile is coarser at least by a factor of 10 than a corresponding micro-profile of the micro-topography, elevations (31′) of the macro-profile have different heights and the micro-profile is in particular quasi-fractal.

The invention relates to a method for manufacturing a thermally sprayed layer, in particular a ceramic coating on a metallic substrate, in accordance with the preamble of claim 1. It also relates to a coated substrate having the sprayed layer manufactured in accordance with the invention and to use of this coated substrate.

In a development of fusion reactors, one wants to use a titanium based alloy (for example Ti5Al2.5Sn) for a wall which must withstand strains at temperatures above 550° C. The use of this material is connected to the problem that in fusion reactors, hydrogen diffuses into the material and thereby unfavourably influences its properties. It has therefore been proposed to seal the said wall with a thermally sprayed layer of ceramic material. The sprayed layer should act as a permeation barrier which prevents the hydrogen from entering the wall material. So that this permeation barrier, which can consist for example of aluminium oxide or chromic oxide, satisfies the expected function, the coating must be relatively thick, at least 0.5 mm, but preferably quite a lot thicker.

Such a permeation barrier can as a rule not be applied to a metallic substrate; since, due to strains which occur between the substrate and the sprayed layer and which result in the formation of cracks, no sufficient adhesion is possible. The adhesion can be improved by a scuffing of the substrate surface, for example by means of sandblasting, by which a quasi-fractal surface structure (cf. EP-A-1 070 488) results. Coatings which have the required thickness can, however, not be anchored sufficiently fixedly on the substrate surface. Tensile tests for determining the bond strength have shown that such coatings detach from the substrate surface at a tensile stress of only a few MPa. In a further method, which has been tested, a “duplex coating” is manufactured with a bond priming base adhesive layer (of Ta). The adhesion between this layer and the permeation barrier is insufficient due to a relatively smooth surface of the base adhesive layer.

It is the object of the invention to provide a method for manufacturing a thermally sprayed layer which can be applied to a metallic substrate made of a titanium based alloy and which can be used as a permeation barrier against hydrogen transport into the substrate. This method should therefore be suitable for applying a coating which has good adhesion, which is thick and consists of a ceramic material, on a metallic body. This object is satisfied by the method defined in claim 1.

In particular a ceramic coating is applied to a metallic body by the method for manufacturing a thermally sprayed layer on a substrate. The sprayed layer is applied to a structured surface of the substrate. The surface structure of the substrate is produced by material removal by means of a high pressure liquid jet, with a removal point being controlledly moved, namely by movement of the liquid jet and/or the substrate, on the substrate while producing a macro-topography. A groove-like removal track is produced by the material removal which can be in a straight line or curved and which has a micro-topography. A macro-profile of the macro-topography is manufactured by placing a plurality of removal tracks next to one another and by partial overlapping of these removal tracks. This macro-profile is coarser at least by a factor of 10 than a corresponding micro-profile of the micro-topography. Elevations of the macro-profile have different heights. The micro-profile is in particular quasi-fractal.

Dependent claims 2 to 6 relate to particular specifications of the method in accordance with the invention. The object of claims 7 and 8 is a body which represents a substrate coated by the method in accordance with the invention. The use which has formed the starting point of the invention is the object of claim 9.

The invention will be explained with reference to the drawings in the following. There are shown:

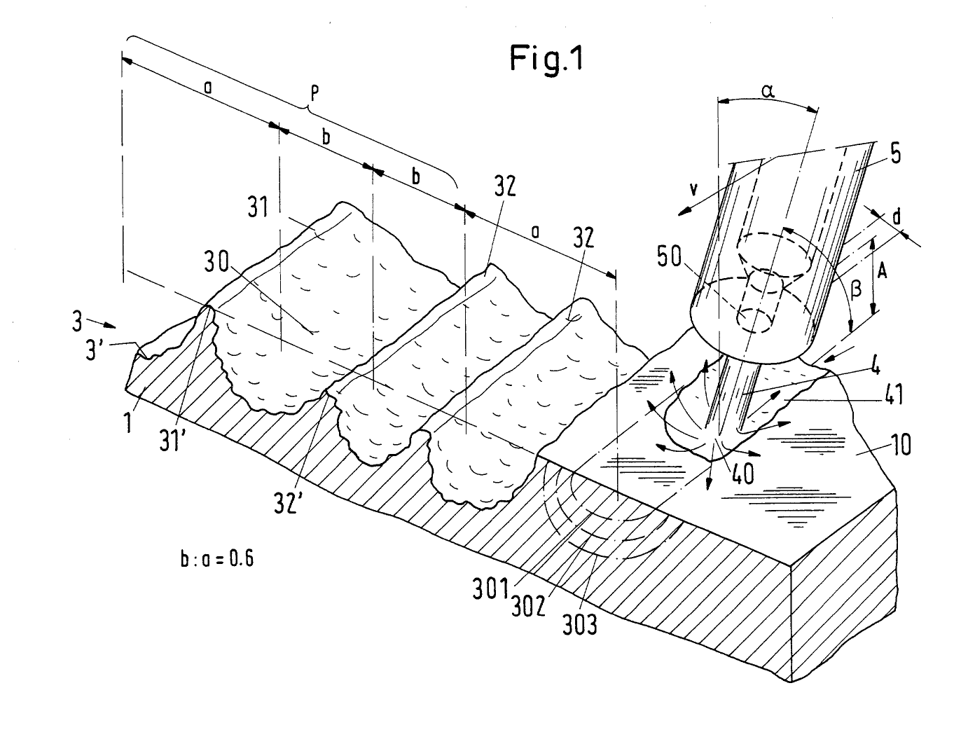

FIG. 1 carrying out of a surface structuring which forms a first step in the method in accordance with the invention;

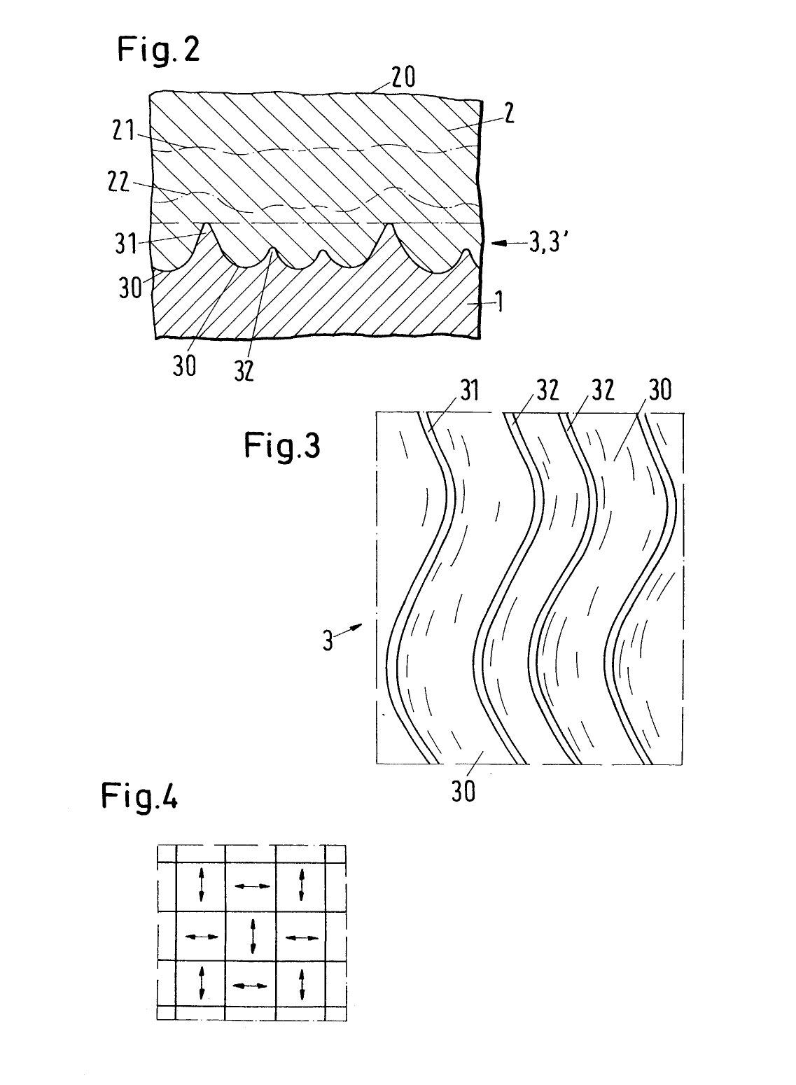

FIG. 2 a cross-section through a substrate coated in accordance with the invention;

FIG. 3 a plan view of a surface structure which has been manufactured by means of corrugated removal tracks;

FIG. 4 a parquet-like surface structure in a schematic representation; and

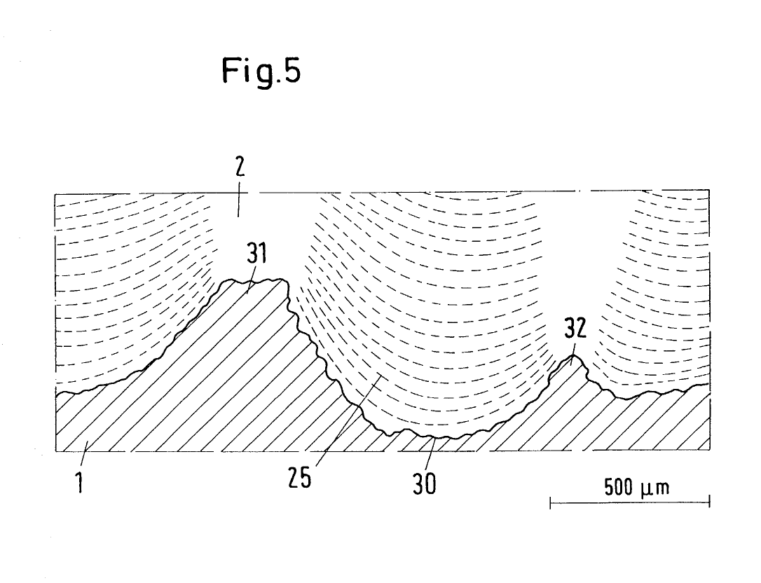

FIG. 5 a cross-section, drawn in accordance with a grinding pattern.

FIG. 1 illustrates a method for manufacturing a surface structure 3 on a substrate 1 which is used as a first step in the method in accordance with the invention. FIG. 2 shows a cross-section through a sprayed layer 3 which has been applied in accordance with the invention onto the substrate 1 having a structured surface 10.

The surface structure 3 is produced by material removal by means of a high pressure liquid jet 4, with a removal point on the substrate 1 being controlledly moved while producing a macro-topography, as a rule by moving the liquid jet at a feed velocity v. However, the substrate can also be moved or both the substrate and the liquid jet simultaneously. A groove-like removal track 41 is produced by the material removal and has a micro-topography in the form of a rough surface. The removal track 41 can be a straight line or curved. A profile of the macro-topography, a macro-profile 3′, is manufactured by placing a plurality of removal tracks 41 next to one another and by partial overlapping of these removal tracks 41. The profile is the contour of the cross-section through the surface structure 3, with the cross-section lying perpendicular to the removal tracks 41. The macro-profile 3′ includes elevations 31′, 32′ which are formed by crest lines 31, 32 disposed between grooves 30. The elevations 31′, 32′ of the macro-profile 3′ have different heights. The macro-profile 3′ is coarser by at least an order of magnitude than a corresponding micro-profile of the micro-topography. The maximum elevations 31′ of the macro-profile are larger by at least a factor of 10 than the maximum elevations of the micro-profile.

The micro-profile is in particular quasi-fractal. The designation “quasi-fractal”, which refers to the roughness of the surface in the removal tracks, is explained in EP-A-1 070 488. A surface structuring is also described in this publication which is carried out by means of a high pressure liquid jet.

Abrasive particles are mixed into the liquid of the high pressure jet for an efficient material removal. This mixture is emitted through a nozzle 5 with a diameter d and at a pressure p. Values in the following ranges are selected for p and d:

500 bar<p<2000 bar and 0.15 mm<d<1 mm.

A spacing A, which is present between a discharge orifice 50 of the nozzle 5 and the removal point 40 of the surface 10 to be treated, amounts to 1 to 5 mm. This spacing A is substantially the jet length, the length of the liquid jet 4. This can be directed perpendicular to the surface 10; an angle β(=90°−α, see FIG. 1) between the liquid jet 4 and the produced removal track 41 is, however, preferably somewhat smaller than 90°.

The grooves 30 and crest lines 31, 32 are manufactured in the structuring of the substrate surface 10. The macro-topography produced has a periodically repeating interval P; this is in each case formed by a plurality of crest lines 31, 32 or grooves 30, preferably two or three crest lines or grooves, arranged next to one another. In the embodiment of FIG. 1, the interval P includes the one crest line 31, which appears as a maximum elevation 31′ in the profile 3′, and the two crest lines 32, which form less high elevations 32. The crest lines 31, 32 extend in a straight line at least regionally and their apexes each lie at a height remaining the same.

A diameter d is selected for the nozzle 5 which lies between 0.18 and 0.5 mm. The periodically repeating interval P is manufactured in the method in accordance with FIG. 1 such that the two grooves 30 adjacent to the high crest line 31 have a spacing a from 0.8 to 1.2 mm—with respect to the centre lines of the grooves 30. The grooves 30 adjacent to the low crest lines 32 each have a smaller spacing b which—with respect to the larger spacing a—is smaller by a factor 0.55 to 0.70, preferably by the factor of 0.6 (FIG. 1). The grooves 30 are made by the overlapping of three removal tracks with intermediate bases 301 and 302 and the base 303 forming the groove 30.

The applied sprayed layer 2—see FIG. 2—has a thickness of at least 0.5 mm, preferably at least 1 mm. The profile 3′ of the macro-topography has a maximum height difference between the apex points of the elevations 31′ and the base points of the grooves 30 which lies in a range between 0.1 and 1 mm, preferably between 0.3 and 0.6 mm.

The surface structure 3 practically no longer stands out on the surface 20 of a thick sprayed layer 2. Instantaneous surfaces 21 or 22, which occur during the application of the sprayed layer 2, still have a profile; however, this becomes constantly less and less recognisable as the layer thickness grows.

FIG. 3 is a plan view of a surface structure 3 which is manufactured by means of corrugated removal tracks 41 and whose crest lines 31, 32 are accordingly also corrugated.

Surface structures 3 were tested in which a first group of removal tracks of the same orientation have a second group of removal tracks of a different orientation in a crossing manner. The bond strength has proved to be less good than with the original surface structuring with only one group of removal tracks 41 of the same orientation.

The substrate consists, for example, of a titanium based or an iron based alloy and the sprayed layer consists of a ceramic material, for example of aluminium oxide or chromic oxide. This ceramic coating has a good adhesion on the metallic substrate; in a tensile test it withstands a tensile strain applied perpendicular to the substrate surface which is at least in the order of 10 MPa.

The sprayed layer, preferably made of aluminium oxide or chromic oxide, can be used with a sufficient thickness as a permeation barrier which seals against a transport of hydrogen into the substrate. The sprayed layer must be thicker than 0.5 mm for a good sealing.

The surface structure 3 to be preferred with respect to the bond strength is anisotropic. A quasi-isotropic structure can be manufactured when a parquet-like arrangement of anisotropic part regions in accordance with FIG. 4 are produced. In this schematic illustration, the double arrows each indicate the orientation of the grooves 30.

Tensile tests were carried out on titanium samples coated in accordance with the invention with the following test parameters for the best coatings: surface structuring with a feed velocity of v=2.5 m/min; nozzle diameter d=0.30 mm; jet length A=1 mm; jet pressure p=1.5 10³ bar; sand (garnet 80 mesh) as the abrasive material with 100 g/min; spacings a, b between adjacent grooves 30 (FIG. 1): a=1.0 mm and b=0.6 mm.

The following measurement results were obtained for the tensile strains at which the sprayed layer is torn off the substrate (Ti5Al2.5Sn):

| Material | Layer thickness | | Measurement results in MPa |
|---|---|---|---|
| Chromic oxide | 0.98 | mm | 29.0/36.6 |
| | 2.10 | mm | 18.3/14.5/13.7/16.4 |
| Aluminium oxide | 0.975 | mm | 24.2/27.3/22.1/23.8 |

Whereas FIG. 2 is the illustration of a schematically represented cross-section through a coated substance in accordance with the invention, FIG. 5 sectionally shows a corresponding cross-section which is drawn in accordance with a real sample. A grinding pattern of this sample allows a lamellar structure to be recognised which is a result of a multiple application and which is indicated by broken lines 25 in FIG. 2. The lamellar structure appears relatively clearly in the regions above the grooves 30 and less clearly in the regions above the crest lines 31 and 32 where the lines 25 are interrupted in the illustration. In the regions above the grooves 30, the layer 2 is evidently somewhat less impermeable than above the crest lines 31 and 32 due to an increased porosity. The different porosity is presumably the reason for the improved adhesion of the layer 2.

1. A method for manufacturing a thermally sprayed layer (2) on a substrate (1), in particular a ceramic coating on a metallic body, in which method the sprayed layer is applied to a structured surface (3, 10) of the substrate,
characterised in that the surface structure (3) of the substrate is produced by material removal by means of a high pressure liquid jet (4); in that therein a removal point (40) is controlledly moved on the substrate while producing a macro-topography, namely by moving the liquid jet and/or the substrate; in that a groove-like removal track (41) is produced by the material removal which can be in a straight line or curved and which has a micro-topography; and in that a macro-profile (3′) of the macro-topography is manufactured by placing a plurality of removal tracks next to one another and by partial overlapping of these removal tracks, with this macro-profile being coarser at least by a factor of 10 than a corresponding micro-profile of the micro-topography, elevations (31′) of the macro-profile having different heights and the micro-profile being in particular quasi-fractal.

2. A method in accordance with claim 1, characterised in that abrasive particles are mixed into the liquid of the high pressure jet (4); in that this mixture is emitted through a nozzle (5) with a diameter d of a discharge orifice (50) and at a pressure p; and in that values in the following ranges are selected for p and d:
500 bar<p<2000 bar and 0.15 mm<d<1 mm.

3. A method in accordance with claim 2, characterised in that a spacing (A) of between 0.8 and 5 mm lies between the discharge orifice (50) of the nozzle (5) and of the surface (10) to be treated; and in that an angle (β=90−α) between the liquid jet (4) and the produced removal track (41) is at maximum equal to 90°, preferably less than 90°.

4. A method in accordance with any one of claims 1 to 3, characterised in that crest lines (31, 32) and grooves (30) are manufactured in the structuring of the substrate surface (10); and in that the produced macro-topography has a periodically repeating interval (P) that is formed in each case by a plurality of crest lines or grooves, preferably two or three crest lines or grooves arranged next to one another.

5. A method in accordance with claim 4, characterised in that the crest lines (31, 32) extend in a straight line at least regionally and lie at a constant height.

6. A method in accordance with claim 4 or claim 5, characterised in that for the high pressure jet (4) a nozzle (5) with a diameter d from 0.18 to 0.5 mm is used; and in that the periodically repeating interval (P) is manufactured such that it includes one high crest line (31) and two low crest lines (32); in that the grooves (30) adjacent to the high crest line have a spacing a from 0.8 to 1.2 mm—with respect to the centre lines of the grooves; and in that the grooves adjacent to the low crest lines each have a smaller, spacing b which—with respect to the greater spacing a—is smaller by a factor 0.55 to 0.70, preferably by the factor of 0.6.

7. A coated substrate (1), manufactured with the method in accordance with any one of claims 1 to 6, characterised in that the applied sprayed layer (2) has a thickness of at least 0.5 mm, preferably at least 1 mm; and in that the profile (3′) of the macro-topography has a maximum height difference between apex points of the elevations (31′) and base points of the removal tracks (41) which lies in a range between 0.1 and 1 mm, preferably between 0.3 and 0.6 mm.

8. A coated substrate (1) in accordance with claim 7, characterised in that the substrate consists of a metallic alloy, in particular of a titanium based alloy or an iron based alloy; in that the coating (2) consists of a ceramic material; and in that the coating withstands a tensile test with a tensile strain applied perpendicular to the substrate surface which is greater than 10 MPa.

9. Use of a coated substrate (1) in accordance with claim 7 or claim 8, wherein the sprayed layer (2) forms a permeation barrier against hydrogen transport into the substrate and preferably consists of aluminium oxide or chromic oxide and has a thickness of more than 1 mm.
